(19) United States
(12) Patent Application Publication
(10) Pub. No.: US 2024/0286706 A1
(43) Pub. Date: Aug. 29, 2024

(54) NON-CIRCULAR BRAKE PISTON

(71) Applicant: SRAM, LLC, CHICAGO, IL (US)

(72) Inventor: CHARLES DUNLAP, MANITOU SPRINGS, CO (US)

(73) Assignee: SRAM, LLC, CHICAGO, IL (US)

(21) Appl. No.: 18/425,502

(22) Filed: Jan. 29, 2024

Related U.S. Application Data
(60) Provisional application No. 63/483,089, filed on Feb. 3, 2023.

(51) Int. Cl. B62L 1/06; B62L 1/00; F16D 65/18; F16D 121/02

(52) U.S. Cl. CPC B62L 1/06; B62L 1/005; F16D 65/18; F16D 2121/02

(57) ABSTRACT

A brake caliper includes a caliper housing having a first cavity. A piston is reciprocally moveable in the cavity. The piston is configured with a non-circular outer periphery defining a cross-sectional area orthogonal to the first axis. A portion of the outer periphery may be defined by a linear portion. The outer periphery may be disposed within an outer periphery of a brake pad coupled to the piston when the outer periphery of the piston is superimposed on a cross-sectional area of the brake pad.

This application claims the benefit of U.S. Provisional Patent Application No. 63/483,089, filed Feb. 3, 2023, which is hereby incorporated by reference in its entirety.

### FIELD OF THE DISCLOSURE

The present application generally relates to a hydraulic brake caliper, including for example and without limitation a hydraulic brake caliper having a non-circular brake piston used on a bicycle.

### BACKGROUND

Bicycles, whether human powered or configured with an electric assist, may include hydraulic brake systems configured with hydraulic brake calipers. Hydraulic brake calipers may include one or more pistons that move one or more brake pads toward a brake rotor. The evolution of bicycling technology, sport, and transportation has led to users riding at higher speeds, on steeper downhill roads and trails, and carrying heavier overall loads. As such, greater braking force may be required to slow and stop the bicycles. While the braking force may be increased by increasing the number and/or size of the caliper pistons, those features may adversely affect the overall performance and cost of the caliper and/or bicycle. For example, manufacturers may strive to reduce the size and/or weight of the brake caliper in order to improve the performance and efficiency of the bicycle, including reducing the aerodynamic drag of the caliper, and the materials and costs associated therewith.

### SUMMARY

In one aspect, one embodiment of a brake caliper includes a caliper housing having a cavity and a piston movably disposed in the cavity. The piston is reciprocally movable in the cavity along a first axis and is configured with a non-circular outer periphery defining a cross-sectional area orthogonal to the first axis. The cross-sectional area includes a major axis having a first length and a minor axis having a second length, wherein the major axis is orthogonal to the minor axis, and wherein a power elongation ratio of the first length to the second length is greater than or equal to 1.5.

In another aspect, one embodiment of a brake caliper includes a caliper housing having a cavity and a piston movably disposed in the cavity. The piston is reciprocally movable in the cavity along a first axis. The piston includes a non-circular first outer periphery defining a first cross-sectional area orthogonal to the first axis. A brake pad is coupled to the piston and is configured with a second outer periphery defining a second cross-sectional area orthogonal to the first axis. The outer periphery of the piston is disposed within the outer periphery of the brake pad when the outer periphery of the piston is superimposed on the cross-sectional area of the brake pad along the first axis.

In yet another aspect, one embodiment of a brake caliper includes a caliper housing having a cavity and a piston movably disposed in the cavity. The piston is reciprocally movable in the cavity along a first axis. The piston includes a non-circular outer periphery defining a cross-sectional area orthogonal to the first axis, wherein the outer periphery is defined by at least one linear portion.

In another aspect, one embodiment of a brake caliper includes a seal disposed between an outer periphery of the brake piston and an interior surface of the cavity. The seal provides a biasing force to the brake piston.

The various aspects and embodiments of the brake caliper configured with a non-circular piston, and the methods for the use and assembly thereof, provide significant advantages over other brake calipers and methods. For example and without limitation, the non-circular piston may increase the hydraulic advantage of the piston and brake without increasing the overall size and/or weight of the caliper. Rather, a greater hydraulic advantage may be achieved within a smaller envelope size, thereby providing increased performance without an increase in materials and cost. At the same time, the relative length of the seal may help reduce the biasing force applied by the seal against the piston when being advanced during braking.

The foregoing paragraphs have been provided by way of general introduction and are not intended to limit the scope of the claims presented below. The various preferred embodiments, together with further advantages, will be best understood by reference to the following detailed description taken in conjunction with the accompanying drawings.

### BRIEF DESCRIPTION OF THE DRAWINGS

Objects, features, and advantages of the present invention will become apparent upon reading the following description in conjunction with the drawing figures, in which:

FIG. 1 is a side view of one embodiment of a bicycle assembled with a hydraulic brake system.

FIG. 2 is a perspective view of one embodiment of a brake caliper.

FIG. 3 is an exploded perspective view of the brake caliper shown in FIG. 2.

FIG. 4 is a top view of the brake caliper shown in FIG. 2.

FIG. 5 is a side view of the brake caliper shown in FIG. 2.

FIG. 6 is an end view of the brake caliper shown in FIG. 2.

FIG. 7 is a cross-sectional view of the brake caliper taken along line 7-7 in FIG. 4.

FIG. 8 is a cross-sectional view of the brake caliper taken along line 8-8 in FIG. 6.

FIG. 9 is a cross-sectional view of the brake caliper taken along line 9-9 in FIG. 4.

FIG. 10 is a perspective view of one embodiment of a brake piston.

FIG. 11 is a top view of the brake piston shown in FIG. 10.

FIG. 12 is a plane view of one embodiment of a piston seal being deformed from a circular configuration to a non-circular configuration.

FIG. 13 is a side view of another embodiment of a brake caliper.

FIG. 14 is an end view of the brake caliper shown in FIG. 13.

FIG. 15 is a cross-sectional view of the brake caliper taken along line 15-15 in FIG. 14.

FIG. 16 is an exploded view of the brake caliper shown in FIG. 13. perspective of an alternative embodiment of a brake caliper and rotor.

FIG. 17 is an enlarged partial view of the brake caliper taken along line 17 in FIG. 15.

FIG. 18 is a perspective view of another embodiment of a brake piston.

FIG. 19 is a top view of another embodiment of a brake piston.

FIG. 20 is a side view of the brake piston shown in FIG. 19.

FIG. 21 is a top view of another embodiment of a brake piston.

FIG. 22 is a side view of the brake piston shown in FIG. 21.

FIG. 23 is an enlarged partial view of the brake piston taken along line 23 in FIG. 22.

FIG. 24 is a perspective view of another embodiment of a brake piston.

FIG. 25 is a cross-sectional view of the brake piston taken along line 25-25 in FIG. 24.

FIG. 26 is a plane view showing one embodiment of a brake piston superimposed on a brake pad.

FIG. 27 is a cross-sectional view of one embodiment of a brake caliper.

FIG. 28 is a perspective view of an embodiment of a piston.

FIG. 29 is a cross-sectional view of one embodiment of a brake caliper.

FIG. 30 is a perspective view of an example sleave.

### DETAILED DESCRIPTION OF THE DISCLOSURE

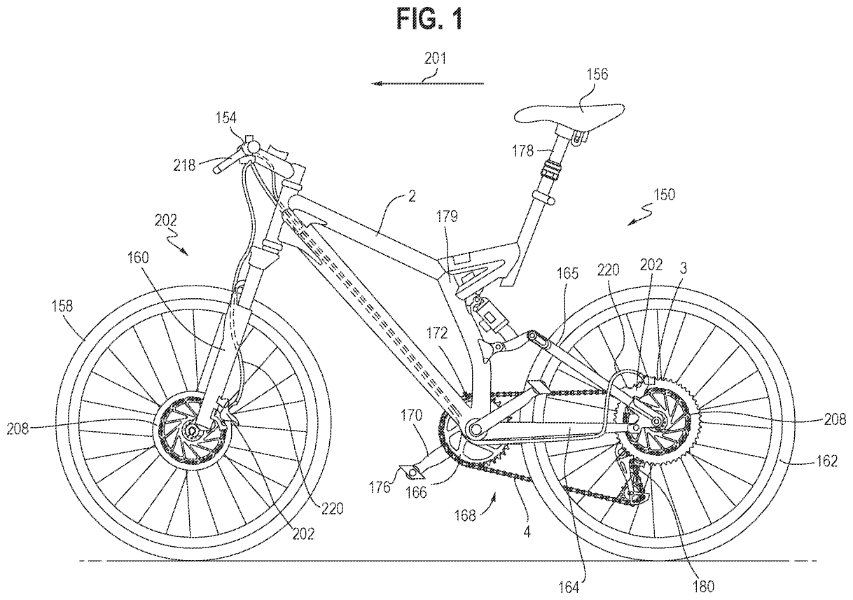

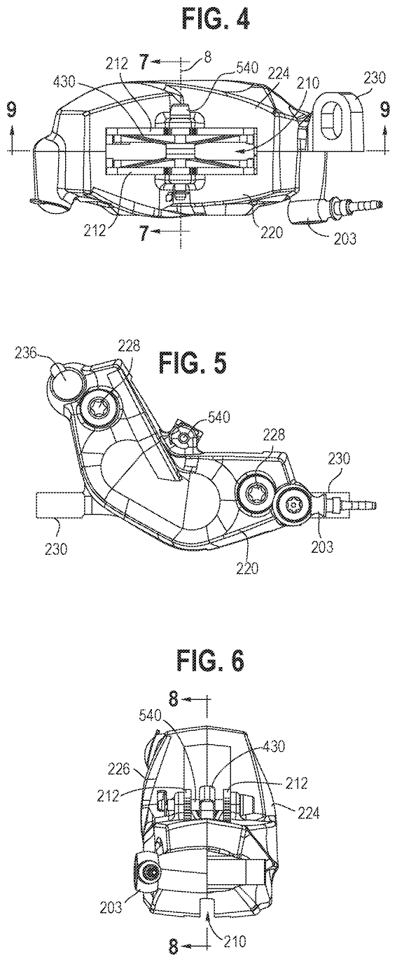

It should be understood that the term “plurality,” as used herein, means two or more. The term “longitudinal,” as used herein means of or relating to a length or lengthwise direction. The term “lateral,” as used herein, means situated on, directed toward or running in a side-to-side or axial direction 8. The term “coupled” means connected to or engaged with, whether directly or indirectly, for example with an intervening member, and does not require the engagement to be fixed or permanent, although it may be fixed or permanent, and includes an engagement by way of pressing one component against another component. The terms “first,” “second,” and so on, as used herein are not meant to be assigned to a particular component so designated, but rather are simply referring to such components in the numerical order as addressed, meaning that a component designated as “first” may later be a “second” such component, depending on the order in which it is referred. It should also be understood that designation of “first” and “second” does not necessarily mean that the two components or values so designated are different, meaning for example a first direction may be the same as a second direction, with each simply being applicable to different components. The terms “upper,” “lower,” “rear,” “front,” “fore,” “aft,” “vertical,” “horizontal,” “right,” “left,” “inboard,” “outboard” and variations or derivatives thereof, refer to the orientations of an exemplary bicycle 150, shown in FIG. 1, from the perspective of a user seated thereon, for example with an “inboard” component or feature being closer to a vertical mid-plane of the bicycle extending in a direction 201. The term “transverse” means non-parallel. The terms “outer” and “outwardly” refers to a direction or feature facing away from a centralized location, for example the phrases “radially outwardly,” “radial direction” and/or derivatives thereof, refer to a feature diverging away from a centralized location, for example an axial direction 8 shown in FIGS. 3, 4 and 7. Conversely, the terms “inward” and “inwardly” refers to a direction facing toward the centralized or interior location. The term “subassembly” refers to an assembly of a plurality of components, with subassemblies capable of being further assembled into other subassemblies and/or a final assembly, such as the bicycle 150.

### Bicycle:

FIG. 1 illustrates one embodiment of a human powered vehicle. In the example shown, the vehicle is one possible type of bicycle 150, such as a mountain bicycle. It should be understood that the various embodiments of the hydraulic brake caliper may be used on other types of human powered vehicles, including for example and without limitation road bicycles. In FIG. 1, a normal riding or forward moving direction 201 of the bicycle 150 is shown. The bicycle 150 has a frame 2, handlebars 154 near a front end of the frame 2, brake levers 218 secured to the handlebars, and a seat or saddle 156 for supporting a rider over a top of the frame 2. The bicycle 150 has a first or front wheel 158 carried by a front fork 160 supporting the front end of the frame 2. The bicycle 150 also has a second or rear wheel 162 supporting a rear end of the frame 2, which includes a pair of chain stays 164 connected to a pair of seat stays 165 at a junction or apex. The bicycle 150 also has a drive train 168 with a crank assembly 166 that is operatively coupled via a bicycle chain 4 to a rear cassette 3, otherwise referred to as a driven sprocket assembly, near a hub providing a rotation axis of the rear wheel 162. The crank assembly 166 includes at least one, and typically two, crank arms 170 and pedals 176, along with a front chainring assembly 172, or drive sprocket assembly. A crank spindle or shaft may connect the two crank arms. The crank shaft defines a center rotational axis of the chainring assembly 172. The crank assembly may also include other components.

A rear gear change device, such as a rear derailleur 180, is disposed at the rear wheel 162 to move the bicycle chain 4 to different sprockets of the cassette 3. In one embodiment, a front gear changer device, or front derailleur, may be provided to move the chain 4 to different sprockets of the chainring assembly. In the illustrated example, the saddle 156 is supported on a seat post 178 having an end portion received in a top of a frame seat tube 179 of the frame 2.

### Brake System:

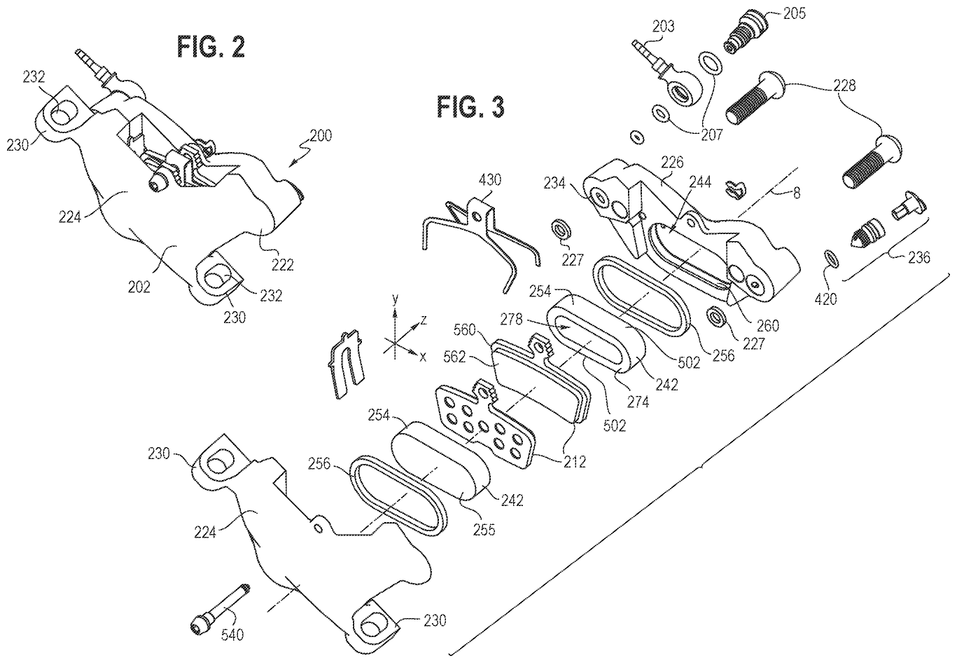

Referring to FIGS. 1-9 and 13-17, a brake system 200 is coupled to the bicycle frame 2, for example the front fork 160, or the rear seat stay 165. The brake system 200 includes a caliper 202 secured to the frame, e.g., front fork 160, for example with a pair of bolts 204, and a rotor 208 secured to the front or rear wheel. The rotor 208 is rotatable relative to the caliper 202 and is disposed within a slot 210 defined by the caliper 202. Referring to FIGS. 2-9, the caliper 202 includes a pair of opposing brake pads 212 that engage opposite sides 214, 216 of the rotor 208 when actuated to slow and/or stop the rotation of the rotor, attached wheel and bicycle. The caliper 202 is in fluid connection with the brake lever 218 by way of a conduit 220, shown for example in FIG. 1. The brake lever 218 may be actuated (e.g., pulled) to increase the hydraulic pressure in the conduit 220 and thereby pressurize the caliper 202, and components therein, so as to actuate the brake pads 212 and move them into engagement with opposite sides 214, 216 of the rotor 208. Separate hydraulic systems may be provided for the front and rear wheels 158, 162, and calipers 202 associated with each wheel.

### Caliper:

Referring to FIGS. 2-9, the caliper 202 includes a housing 222, configured in one embodiment with an outboard caliper portion 224 and an inboard caliper portion 226, which are secured to each other to form and define the rotor slot 210. The caliper portions may be secured or coupled to each other, for example, with fasteners 228, shown as a pair of bolts. The caliper housing 222, including the outboard and inboard portions 224, 226, may be made from aluminum alloy, or other similar and/or suitable materials. The housing 222 includes a mounting arrangement 230, shown in one embodiment as a pair of platforms, which are configured to be mounted to a base components, including for example and without limitation a vehicle frame, fork 160, or chassis member. In one embodiment, the mounting arrangement 230 includes one or more mounting holes 232 located on the outboard caliper portion 224, with a pair of fasteners securing the housing to the base component. Other configurations of the mounting arrangement may include one or more of mounting holes, slots, threads, dovetail features, or clamping mechanisms, which may be used to mount the caliper to a vehicle member, with these configuration features being disposed on either the inboard or the outboard caliper portion. For example, as shown in FIG. 15, a flat mount configuration is shown, with threaded fastener openings 231 formed in the caliper housing.

As shown in FIGS. 2, 3 and 8, the caliper housing 222 includes a fluid inlet having a port 234 and configured with a fitting 203 secured to the housing with a fastener 205 and seals 207 in one embodiment. A seal 227 is disposed between the housing components. The fitting 203 and port 234 are in fluid communication with the conduit 220 for communicating hydraulic fluid to and from the hydraulic pump or master cylinder actuated by the lever 218. A bleed fitting 236, inserted into a bleed port 238, is used for filling the caliper with hydraulic fluid and/or for evacuating air in a bleeding process. The fluid inlet, or port 234, is in fluid communication with a piston 242 disposed in a cavity 244 defined by the housing 222. The bleed port 238 and the fluid inlet, or port 234, are in fluid communication with each other via the cavity 244, which has a non-circular cross section and which receives the piston 242. In one embodiment, the ports 234, 238 communicate with the cavity 244 adjacent, or close to, the closed end of cavity to allow for unrestricted fluid flow to the piston 242.

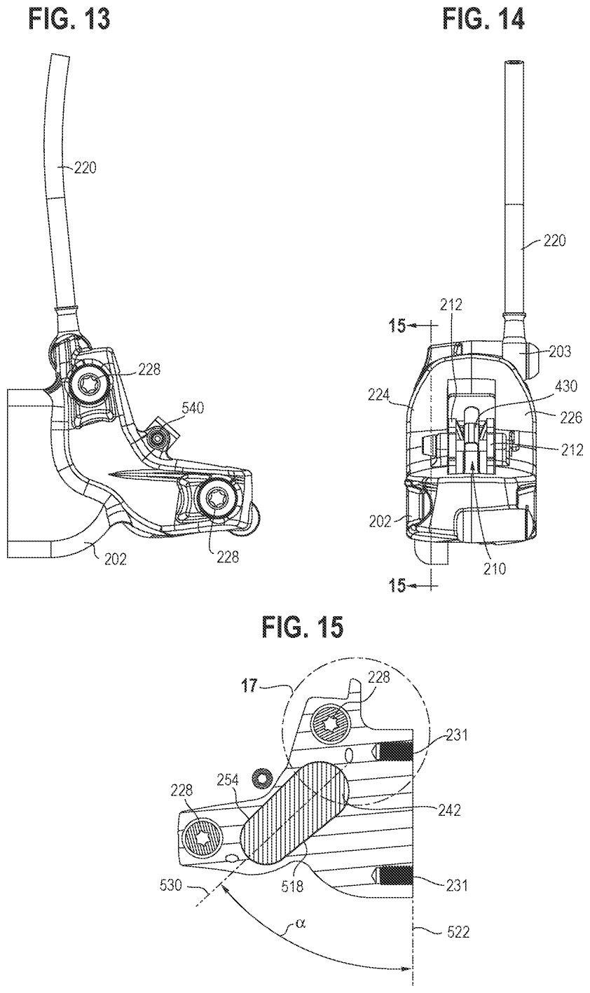

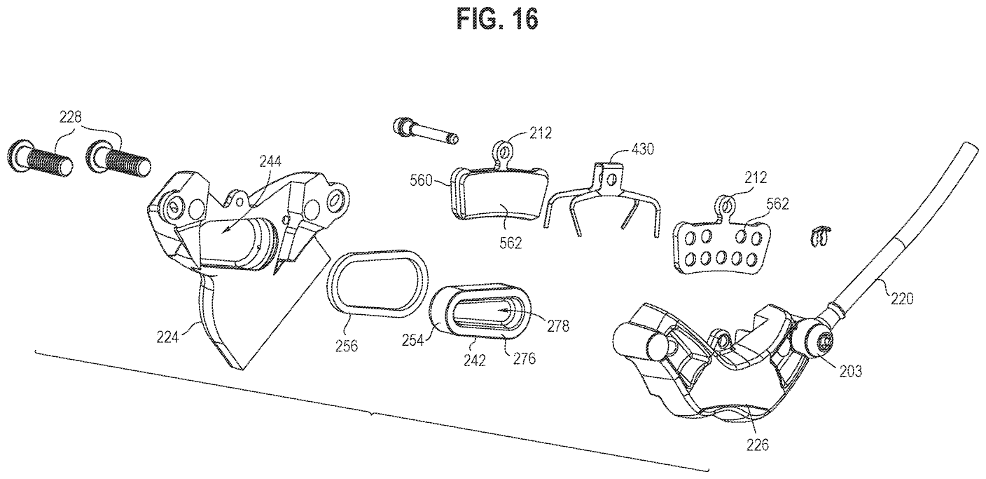

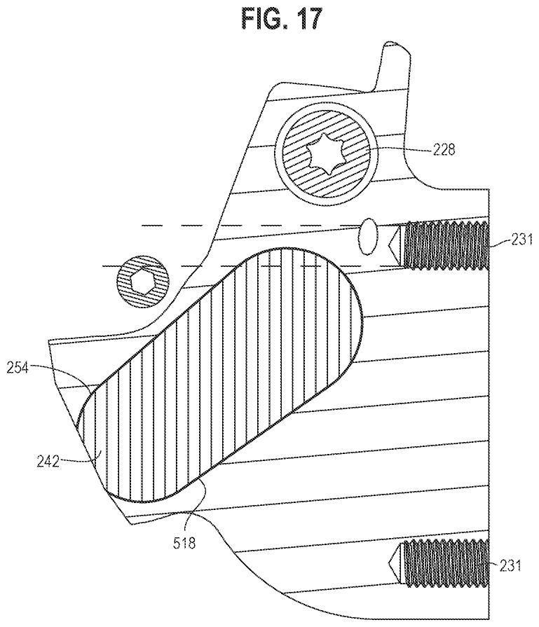

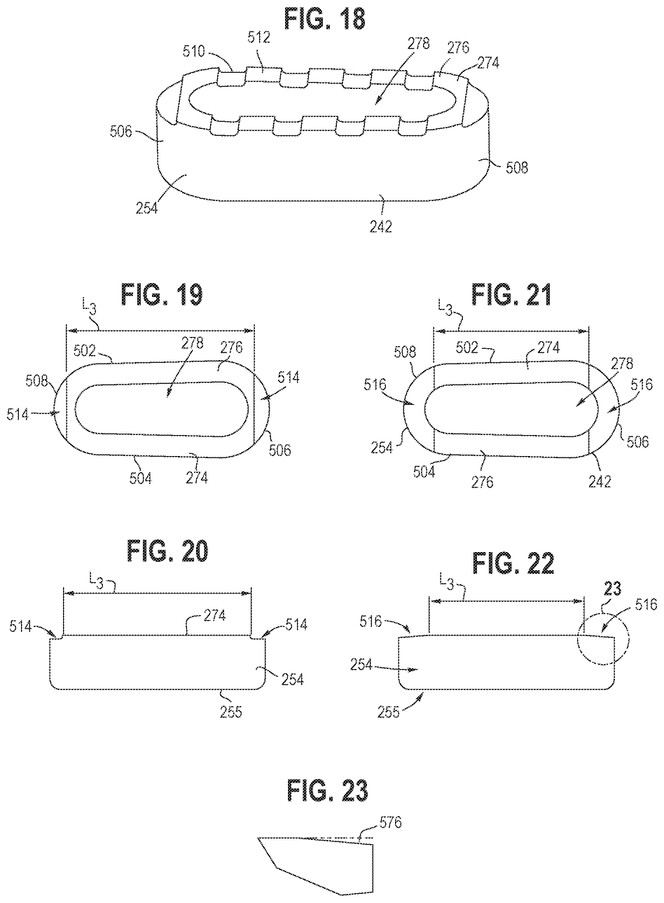

In one embodiment, shown in FIGS. 13-16, the caliper 202 may include an actuating inboard caliper portion 226 and a non-actuating outboard caliper portion 224. The actuating and non-actuating caliper portions 226, 224 may also be switched to the outboard and inboard portions respectively. In other embodiments, shown for example in FIGS. 2-9, the caliper may include both inboard and outboard caliper portions 224, 226 with an actuating function. In one embodiment, the fasteners 228 slide through the outboard caliper portion 224 and threadably engage the inboard caliper portion 226 to create the caliper housing 222 as shown in FIG. 16. Conversely, the bolts may slide through the inboard caliper portion and threadably engage the outboard caliper portion as shown in FIG. 3. The inboard caliper portion 226 and outboard caliper portion 224 may be fastened to one another with screws, bolts, rivets, tabs, snap-fit and/or welding, or may be configured as a single unitary piece. In one embodiment, which includes only a single actuating caliper portion, the non-actuating portion, e.g., outboard caliper portion, is not configured with any hydraulic chambers, cavities, or features, and when assembled one brake pad will be disposed on flat exposed surface of the caliper portion.

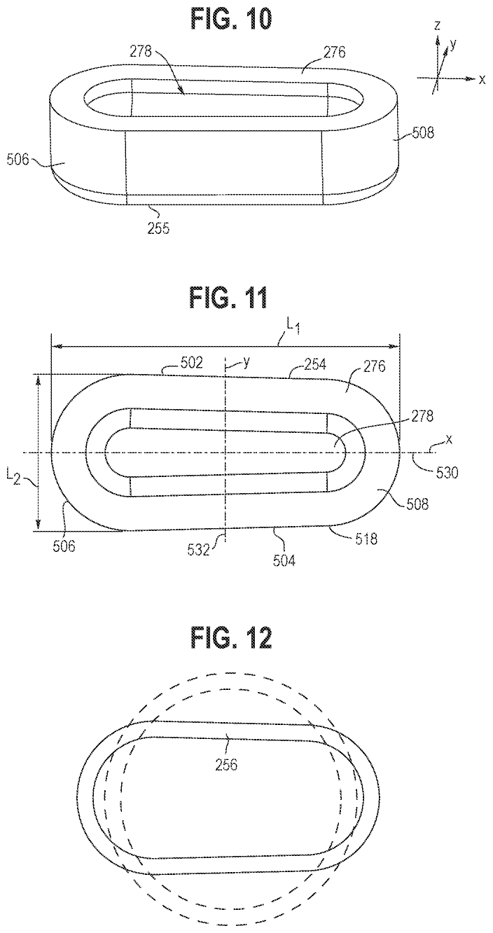

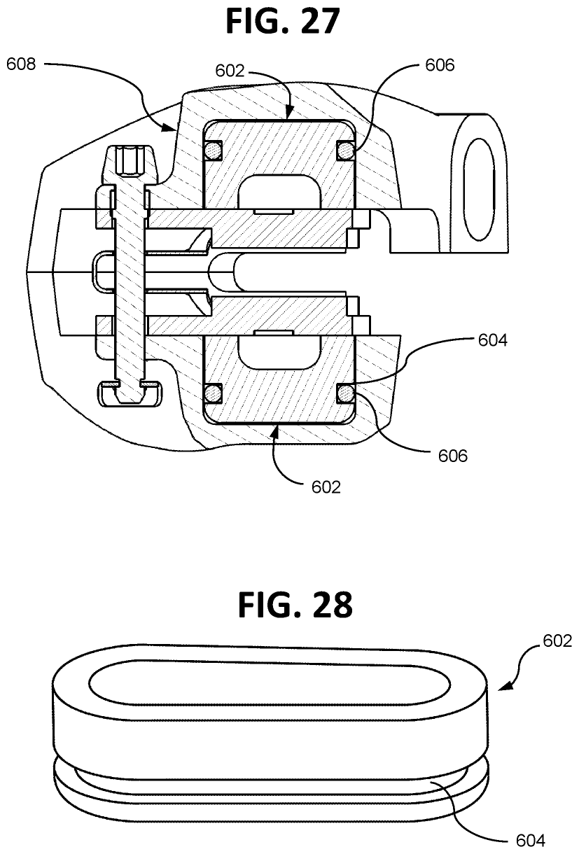

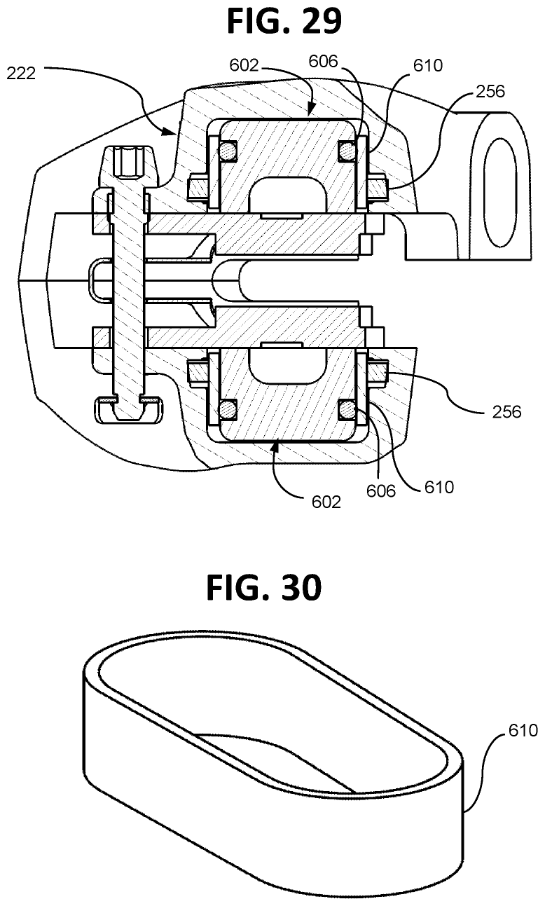

In the embodiment of FIGS. 2-9, both actuating caliper portions 224, 226 include a piston 242 in fluid communication with the hydraulic fluid, while in the embodiment of FIG. 16, only the outboard caliper portion 224 is configured with the piston 242. In either embodiment, the caliper housing 222, for example the inboard caliper portion 226, has an interior surface 246 defining the cavity 244. The piston 242 has an exterior peripheral surface, defined by the outer periphery 254. The peripheral surface is normal to the X/Y plane shown in FIGS. 10 and 11, and extends in the Z direction, with a projection of the surface onto the X/Y plane defining the periphery 254. A seal 256 is disposed between and engages the interior surface 246 and the exterior peripheral surface defined by the periphery 254. It should be understood that in other embodiments, for example as is illustrated in FIGS. 28-30, a sleeve 610 may be disposed between the piston 602 and the cavity, with a seal 256, or a first seal, interfacing between the sleeve 610 and cavity, and another seal 606, or a second seal, interfacing between the sleeve 610 and the piston 602.

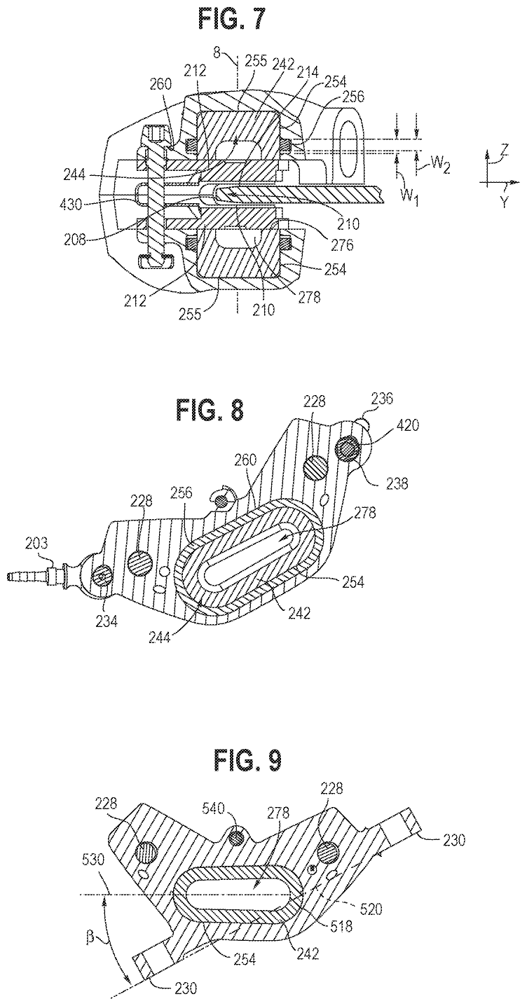

The seal 256 is shown in the drawings in an uncompressed state in FIG. 7, with the profile extending outside of a gland 260 housing the seal. It should be understood that the seal 256 is, in actuality, compressed to fit within the gland 260. The seal is shown in the uncompressed state to provide clarity about the shape of the seal and the size thereof relative to the gland. Furthermore, as shown in FIG. 12, in one embodiment, a seal 256′ may initially have a circular configuration, and thereafter be deformed to a seal 256 having a non-circular configuration matching the exterior periphery of the piston 242.

As shown in FIGS. 3 and 7, a peripheral or annular groove extends peripherally around the first cavity 244, and defines the peripheral or annular gland 260, which houses the seal 256. The gland 260 has a first width (W1) defined in the axial direction 8 and the seal 256 has a second width (W2) defined in the axial direction 8, wherein the first width (W1) is greater than the second width (W2). The gland may be stepped and include first and second portions with different shapes to define a shoulder or stop surface at the junction therebetween. In one embodiment, the seal 256 is deformable in the gland as the piston 242 is moved, e.g., slid, relative to the caliper housing 222. When the brake lever is released, the seal 256 biases the piston 242 from an actuated position toward an at-rest position.

As shown in FIGS. 3 and 8, a bleed fitting seal 420 creates a seal between the bleed fitting 236 and the inboard caliper portion 226. Opposite the bleeding fitting is the fluid inlet sealed from the atmosphere by the conduit 220 and port 234 configured with a fitting. Together, the seal 256, bleed fitting seal 420, and hose connection with the fitting 203 at the port 234 seal the brake fluid system from communicating with the ambient environment or atmosphere. A pad spreader spring 430 biases the brake pads 212 away from the brake rotor 208, and maintains engagement, or a coupling, between the brake pad(s) 212 and the piston(s) 242, or caliper portion 224 in a single actuated system. The piston seal 256 biases the piston(s) 242 to a resting position, and the pad spreader spring 430 biases the brake pads 212 against the piston(s) 242, or caliper housing.

The piston 242 is disposed in the cavity 244, and is reciprocally slidable in the cavity 244 relative to the caliper housing along the axial direction 8, or the Z axis. The piston 242 includes an peripheral seal surface defining the periphery 254. The piston 242 has an axial facing brake pad surface 274 in contact with the brake pad 212. The piston 242 may be made from phenolic, aluminum, stainless steel, or other similar and suitable polymers or metals. In one embodiment, the piston 242 has a U shape in cross section, with an annular rib 276 defining a central cavity 278 and the surface 274 engaging the brake pad 212. In an embodiment, as illustrated in FIGS. 27 and 28, the piston 602 may be configured with an annular groove 604, defining a gland, with a piston seal 606 disposed in the gland 604 and slidingly engaging a caliper housing 608. The caliper housing 608 similar to the caliper housing 222 as illustrated in FIG. 2 and adapted for the piston 602. For example, the housing does not include the gland. The seal 606 may be different than the seal 256 previously described. For example, the seal 606 may be formed such that there the interaction with a sealing surface on the housing 608 or sleave 610 provides for sliding in both directions of movement during operation. For example, the seal 606 may be a rounded or cylindrical form in cross section.

As shown in FIGS. 3 and 8-11, the piston has a non-circular outer periphery 254 defining a cross-sectional area that is orthogonal to the axis 8, or Z axis. The cross-sectional area is defined by and corresponds to the surface 255 of the piston, facing away from the brake pad and superimposed on the X/Y plane, that is acted upon by the hydraulic fluid. In one embodiment, the cross-sectional area, or superimposed brake pad surface acted upon by the hydraulic fluid, is defined by a major axis 530 having a first length (L1), extending in the X direction, and a minor axis 532 having a second length (L2), extending for example in the Y direction, wherein the major axis is orthogonal to the minor axis. The phrase “major axis” refers to an axis defining the greatest linear dimension of the piston, while the “minor axis” refers to the greatest linear dimension of the piston that is orthogonal to the major axis, and may or may not define the smallest linear dimension of the piston, for example where the piston has a symmetrical shape. The ratio of the first length (L1) of the major axis to the second length (L2) of the minor axis, which is otherwise referred to as a power elongation ratio, is greater than or equal to 1.5, and in one embodiment, greater than or equal to 2.0. The piston may be nonsymmetric, for example, relative to a centerline axis extending in a Y direction, as shown in FIG. 11. The piston may be symmetric relative to a centerline axis extending in the X direction. In one embodiment, shown in FIGS. 10 and 11, the major axis is 35.6 mm, while the minor axis is 16 mm, such that the power elongation ratio is 2.2. The length of the outer perimeter, or periphery, is 88.9 mm.

An increase in hydraulic surface area, or the cross-sectional area of the piston exposed to the hydraulic fluid, increases the normal force applied by the piston and the corresponding braking force for a given pressure, with Force=Pressure×Area. In this way, a two-piston caliper configured with two non-circular pistons has a larger cross-sectional area than the cross-sectional area of similarly sized four-piston calipers with conventional, circular pistons. For example, one embodiment of the piston has a cross-sectional surface area of 500 mm² as compared to four (4) circular pistons with a diameter equal to the minor axis, and which has a piston cross-sectional surface area of 350 mm². As such, the resulting increase in brake force is proportional to the increase in piston surface area. In one embodiment, only a single non-circular piston 242 is coupled to and associated with an individual brake pad 212, meaning for example the caliper 202 may include only one piston when one of the brake pads is unactuated, or may include a pair of pistons when both brake pads are actuated.

In addition, the length of the perimeter of the piston, or length of the periphery, determines the length of the piston seal 256, which extends around the periphery. As discussed, the piston seal 256 provides a spring bias force to the piston 242 to retract and maintain the piston in the at-rest position with the brake pads 212 spaced from the rotor 208 to forms respective gaps therebetween. As the length of the seal 256 is increased, the piston seal spring bias force is also increased. As the spring bias force is increased, however, the piston advancement force also is increased, leading to greater user input force required to actuate the brakes, and may create a corresponding undesired vague sense of braking force initiation. By reducing the spring force applied by the seal 256, the user may be better able to sense and modulate the braking force.

For example, a four, circular piston brake system having the same hydraulic surface area as a two non-circular piston brake system, may have a greater overall or cumulative seal length, with the four circular piston brake system thereby having a greater spring bias and reduced modulation. In addition, a four, circular piston brake system having the same hydraulic surface area as a two non-circular piston brake system requires a larger caliper body and larger brake pad to package the four pistons. This may result in an undesirable larger and heavier brake caliper. In this way, the non-circular piston(s) maximize the hydraulic surface area, while minimizing the caliper body and brake pad size, and also minimizing the piston seal spring bias. Alternate embodiments may include a single sided non-circular piston caliper with no opposing piston, or may have more than two non-circular pistons on a single side, or on both sides. The caliper may be a one-piece body without connecting body bolts. The caliper may be a standard post-mount configuration, as shown in FIG. 9, or as a flat-mount configuration, as shown in FIG. 15. Mounting bolt hole projections may extend to intersect the non-circular piston. Other radial and axial mounting configurations are possible.

The cross-sectional shape of the piston 242, which is orthogonal to the axis 8 and defined in the X/Y plane, and is defined by the surface 255 projected onto the X/Y plane in one embodiment, may be oval, obround, general oval, stadium oval, elliptical, square with rounded corners, rectangular with rounded corners, triangular with rounded corners, egg shaped, FIG. 8 shaped, intersecting circular shape, and/or any other polygonal shape, with or without rounded corners. The piston perimeter geometry, or periphery 254, may have at least one linear portion, including for example at least two parallel linear edges 502 as shown in FIG. 3, or at least two non-parallel linear edges 502, 504 as shown in FIGS. 8-11, 19 and 21. The periphery may have a concave or convex portion. The piston perimeter geometry, or periphery 254, may have opposite first and second curved end portions 506, 508 having respective first and second radii, with the first radius being the same as the second radius, or wherein the first radius is greater than the second radius. The periphery may have more than one non-concentric radii with axes greater than 3 mm from each other when axes are measured perpendicular from each other. In various embodiments, the two end profiles, or portions 506, 508, have different shapes, including for example the pad trailing end portion having a greater cross-sectional size than the leading end portion, and with the first profile, or portion 506 a greater distance from mounting surface than the second profile, or portion 508.

As noted above, the brake pad facing surface 274 of the piston has a reduced surface area relative to the cross-sectional area defined by the superimposed surface 255. The surface 274 may be defined for example by the rib 276 surrounding the cavity 278 as shown in FIGS. 10 and 11. The rib 276 may further be configured with scallops or recesses 510, which creates a plurality of spaced apart contact brake pad contact surfaces 512 on the same plane. The recesses 510 provide for air flow and create less contact area, defined by the surfaces 512, with an attendant cooling associated therewith by way of convection and conduction. One or both of the ends of the piston contact surface may also be provided with a relief, defined for example by a chamfer 516 or scallop 514, which reduces the effective length (L3) of the contact surface of the piston 242 that engages the brake pad 212, relative to the overall length L1 of the piston 242. The reduction in effective length, in turn, reduces the moment or bending force applied by the outermost end portions of the piston, which may tend to damage or deform adjacent components, such as a non-planar bleed block.

As shown in FIG. 9, the profile 518 of the piston, defined by the outer periphery 254, may intersect a plane 520 of the mounting surface of one embodiment of a caliper housing, while in the embodiment of FIG. 15, the profile 518 of the piston does not intersect or overlap with the mounting plane 522. As shown in FIG. 15, the major axis 530 of the piston defines an acute angle α relative to the mounting plane 522, while in FIG. 9, the major axis 530 of the piston defines an acute angle β relative to the mounting plane 520, with α and β both being between 0 degrees and 90 degrees. A brake pad guide pin 540, which couples the brake pads 212 to the caliper housing 202, lies along the centerline of the piston 242 in one embodiment, but may be offset in other embodiments.

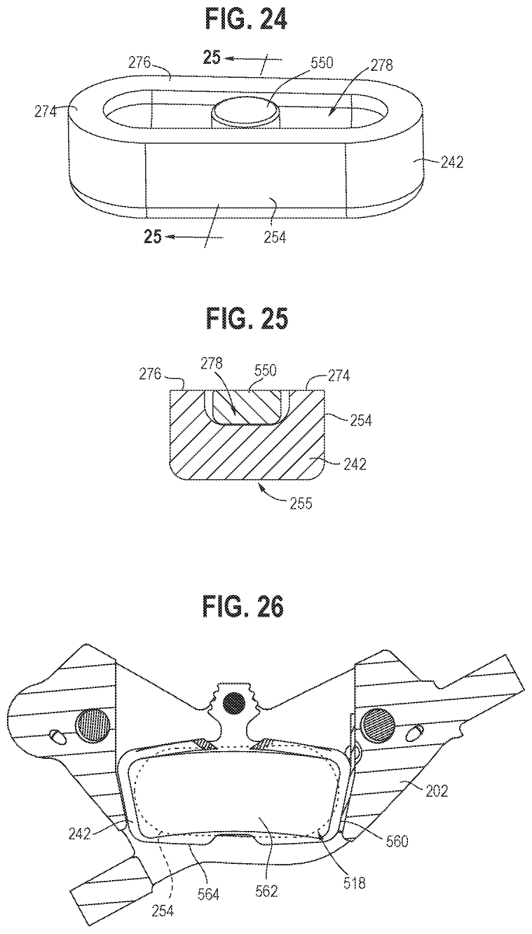

Referring to FIGS. 24 and 26, in addition to engagement therebetween, the piston 242 may be further coupled to the brake pad 212 with a fastening member 550, including for example a magnet disposed in the cavity of the piston and having a face or surface 552 flush with the face or surface 274 of the piston. The fastening member 550 may be secured to the piston 242, for example with adhesive. In one embodiment, where the fastening member 550 is configured as a magnet, the fastening member may magnetically engage or attract the back plate portion 560 of the brake pad. In other embodiments, the fastening member may be configured as a clip, tie, screw, tab, or other mechanical fastener.

As shown in FIG. 26, the brake pad 212, which is engaged by and thereby coupled to the piston 242 by way of that engagement, includes both the back plate portion 560 and a pad portion 562. The brake pad 212 has a second outer periphery 564 defining a second cross-sectional area orthogonal to the axis 8, defined by the Z axis, and superimposed on the X/Y plane. In one embodiment, the back plate portion 560 overhangs from the pad portion 562 and defines the outer periphery 564. In one embodiment, the outer periphery 254, or profile 518, of the piston 242 is disposed within the outer periphery 564 of the brake pad when the outer peripheral surface, or periphery 254, of the piston is superimposed on the cross-sectional area of the brake pad along the axis 8, e.g., Z axis, as shown in FIG. 26. In one embodiment, the length and height dimensions of the supporting backing plate portion of the brake pad exceeds the length and height dimensions of the piston perimeter geometry.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations and/or acts are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that any described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

Although embodiments have been described for illustrative purposes, those skilled in the art will appreciate that various modifications, additions, and substitutions are possible, without departing from the scope and spirit of the disclosure. It is therefore intended that the foregoing description be regarded as illustrative rather than limiting, and that it be understood that all equivalents and/or combinations of embodiments and examples are intended to be included in this description.

Although certain parts, components, features, and methods of operation and use have been described herein in accordance with the teachings of the present disclosure, the scope of coverage of this patent is not limited thereto. On the contrary, this patent covers all embodiments of the teachings of the disclosure that fairly fall within the scope of permissible equivalents.

What is claimed is:

1. A brake caliper comprising:
a caliper housing comprising a cavity; and
a piston movably disposed in the cavity, wherein the piston is reciprocally movable in the cavity along a first axis, and wherein the piston comprises a non-circular outer periphery defining a cross-sectional area orthogonal to the first axis, wherein the cross-sectional area comprises a major axis having a first length and a minor axis having a second length, wherein the major axis is orthogonal to the minor axis, and wherein a power elongation ratio of the first length to the second length is greater than or equal to 1.5.

2. The brake caliper of claim 1 further comprising a seal disposed between the outer periphery and an interior surface of the cavity.

3. The brake caliper of claim 1 wherein the outer periphery is defined by at least one linear portion.

4. The brake caliper of claim 3 wherein the at least one linear portion comprises spaced apart first and second linear portions connected with first and second end portions.

5. The brake caliper of claim 4 wherein the first and second linear portions are non-parallel.

6. The brake caliper of claim 5 wherein the first end portion is curved and has a first radius and the second end portion is curved and has a second radius, wherein the first radius is greater than the second radius.

7. The brake caliper of claim 1 wherein the power elongation ratio of the first length to the second length is greater than or equal to 2.0.

8. The brake caliper of claim 1 further comprising a brake pad coupled to the piston, wherein the brake pad comprises an outer periphery defining a cross-sectional area orthogonal to the first axis, wherein the outer periphery of the piston is disposed within the outer periphery of the brake pad when the outer periphery of the piston is superimposed on the cross-sectional area of the brake pad along the first axis.

9. The brake caliper of claim 1 further comprising a brake pad, and wherein the piston comprises a single piston coupled to the brake pad.

10. A brake caliper comprising:
a caliper housing comprising a cavity;
a piston movably disposed in the cavity, wherein the piston is reciprocally movable in the cavity along a first axis, and wherein the piston comprises a non-circular first outer periphery defining a first cross-sectional area orthogonal to the first axis; and
a brake pad coupled to the piston, wherein the brake pad comprises a second outer periphery defining a second cross-sectional area orthogonal to the first axis, wherein the outer periphery of the piston is disposed within the outer periphery of the brake pad when the outer periphery of the piston is superimposed on the cross-sectional area of the brake pad along the first axis.

11. The brake caliper of claim 10 wherein the first cross-sectional area comprises a major axis having a first length and a minor axis comprising a second length, wherein the major axis is orthogonal to the minor axis, and wherein a power elongation ratio of the first length to the second length is greater than 1.0.

12. The brake caliper of claim 10 further comprising a seal disposed between the first outer periphery and an interior surface of the cavity.

13. The brake caliper of claim 10 wherein the outer periphery is defined by at least one linear portion.

14. The brake caliper of claim 13 wherein the at least one linear portion comprises spaced apart first and second linear portions connected with first and second end portions.

15. The brake caliper of claim 14 wherein the first and second linear portions are non-parallel.

16. The brake caliper of claim 1 wherein the brake caliper further includes a sleave disposed between the piston and the caliper housing.

17. A brake caliper comprising:
a caliper housing comprising a cavity; and
a piston movably disposed in the cavity, wherein the piston is reciprocally movable in the cavity along a first axis, and wherein the piston comprises a non-circular outer periphery defining a cross-sectional area orthogonal to the first axis, wherein the outer periphery is defined by at least one linear portion.

18. The brake caliper of claim 17 wherein the at least one linear portion comprises spaced apart first and second linear portions connected with first and second end portions.

19. The brake caliper of claim 18 wherein the first and second linear portions are non-parallel.

20. The brake caliper of claim 19 wherein the first end portion is curved and has a first radius and the second end portion is curved and has a second radius, wherein the first radius is greater than the second radius.
